(19) United States
(12) Patent Application Publication
(10) Pub. No.: US 2010/0204621 A1
(43) Pub. Date: Aug. 12, 2010

(54) WALKING ASSIST DEVICE

(75) Inventors: Jun Ashihara, Saitama (JP); Yasushi Ikeuchi, Saitama (JP); Hiroshi Kudoh, Saitama (JP); Yutaka Hiki, Saitama (JP); Tatsuya Noda, Saitama (JP); Takeshi Koshiishi, Saitama (JP)

Correspondence Address: RANKIN, HILL & CLARK LLP, 38210 GLENN AVENUE, WILLOUGHBY, OH, 44094-7808, US

(73) Assignee: HONDA MOTOR CO., LTD, Tokyo (JP)

(21) Appl. No.: 12/671,599

(22) PCT Filed: Apr. 15, 2008
(86) PCT No.: PCT/JP2008/057358

§ 371 Date: Feb. 1, 2010

(30) Foreign Application Priority Data
Aug. 3, 2007 (JP) 2007-202996

(51) Int. Cl. A61H 1/00

(52) U.S. Cl. 601/34

(57) ABSTRACT

A walking assist device having a load transmit portion, a leg link connected to the load transmit portion, and a driving source capable of driving the leg link in a direction to raise a seat member, so that at least a partial weight of a user may be supported by the leg link through the load transmit portion. An electric component to be used for controlling the driving source can be mounted on the walking assist device without degrading the compactness of the walking assist device. At least a part of the leg link is constituted of a cylindrical link member in which at least the electric component, such as a motor driver to be used for the control of the driving source, is partially housed. The walking assist device also includes a heat transfer member for absorbing the heat of the electric component by the cylindrical link member. The heat transfer member is thermally connected to a side plate of the cylindrical link member directed toward the side opposite to the leg of the user.

### PRIORITY CLAIM

The present application is based on and claims the priority benefit of Japanese Patent Application 2007-202996 filed on Aug. 3, 2007, the contents of which are incorporated herein by reference in its entirety.

### BACKGROUND OF THE INVENTION

1. Field of the Invention

The present invention relates to a walking assist device which assists a user in walking by relieving a load applied to a leg thereof.

2. Description of the Related Art

Conventionally, there has been known a walking assist device having a seat member, a leg link connected to the load transmit portion and provided with at least one joint portion and a driving source for driving the joint portion provided in the leg link (for example, refer to Japanese Patent Laid-open No. 2007-20909). The driving source in this type of walking assist device drives the leg link in the direction of pushing up the seat member; therefore, at least a partial weight of a user is supported by the seat member through the leg link, and as a result thereof, the walking assist device can assist the user in walking by relieving a load applied to a leg thereof.

In this type of the walking assist device, the load transmit portion is configured as a seat member where the user sits astride, and the leg link is disposed inward the leg of the user in the lateral direction thereof. According thereto, the seat member and the leg link are positioned below the hip of the user, and consequently, a hand of the user will not hit the load transmit portion and the leg link while walking. Therefore, free hand swing in walking is enabled, making the walking assist device more convenient for use.

However, in the conventional walking assist device, electric components such as a controller for controlling the driving source, a motor driver and the like are housed in a backpack, and the backpack is shouldered by the user, which becomes a burden to the user. Thereby, it is expected to relieve the burden from the user by disposing the electric components in the walking assist device.

### SUMMARY OF THE INVENTION

The present invention has been accomplished by improving conventional arts in view of the aforementioned problems, and it is therefore an object of the present invention to provide a walking assist device capable of relieving a burden from a user by disposing an electric component in the walking assist device.

To accomplish an object described above according to the present invention, a first aspect of the present invention provides a walking assist device which comprises a load transmit portion, a leg link connected to the load transmit portion and provided with at least one joint portion and a driving source for driving the joint portion provided in the leg link, and supports at least a partial weight of a user with the leg link through the load transmit portion by operating the driving source to drive the joint portion to make the leg link push up the load transmit portion, wherein the leg link is at least partially constituted of a cylindrical link member; the cylindrical link member is configured to house at least partially an electric component for controlling the driving source; and the cylindrical link member and the electric component housed in the cylindrical link member are thermally connected by a heat transfer member.

A second aspect of the present invention provides a walking assist device which comprises a load transmit portion composed of a seat member where a user sits astride, a leg link connected to the load transmit portion and provided with at least one joint portion and a driving source for driving the joint portion provided in the leg link, and supports at least a partial weight of the user with the leg link through the load transmit portion by operating the driving source to drive the joint portion to make the leg link push up the load transmit portion, wherein the seat member is configured to house at least partially an electric component for controlling the driving source; a heat transfer member is disposed at a surface of the seat member opposite to the other surface thereof contacted by the user; and the heat transfer member is thermally connected to the electric component disposed in the seat member.

Since the walking assist device is compactly designed, it is not easy to provide a space to dispose the electric component. However, according to the first aspect of the present invention, by making good use of the long link member constituting the leg link as a disposing space for the electric component, the electric component can be reasonably disposed in the walking assist device without degrading the compactness thereof. Consequently, the burden to the user can be relieved.

According to the first aspect of the present invention, the link member housing the electric component is formed into a cylindrical shape and the electric component is disposed inside the cylindrical link member, the protection of the electric component against mechanical damage, dust and water can be achieved without the need of providing extra covering members. Moreover, even the built-in electric component generates heat when electrified, since the cylindrical link member is long and has a relatively greater heat capacity, the heat generated by the electric component can be transferred to the cylindrical link member through the heat transfer member and absorbed by the cylindrical link member. Accordingly, there is no need to provide a special cooling device for the electric component, which contributes to the compactness of the walking assist device.

Further, if the cylindrical link member is made of dielectric material, the built-in electric component can be protected against external electromagnetic waves, and as a result thereof, malfunctions due to incoming noises can be prevented.

Furthermore, in the first aspect of the present invention, the load transmit portion is composed of a seat member where the user sits astride, the leg link is positioned inward a leg of the user in a lateral direction of the leg, and it is desirable to thermally connect the heat transfer member to a side plate disposed inward the cylindrical link member in a lateral direction of the cylindrical link member. According thereto, the temperature of the side plate at the outer side of the cylindrical link member, facing the leg of the user in the lateral direction, will not become too high even though the heat generated by the electric component is absorbed by the cylindrical link member. Thus, the user will not feel uncomfortable by the heat applied to the leg thereof.

According to the second aspect of the present invention, by making good use of the seat member as a disposing space for the electric component, the electric component can be reasonably disposed in the walking assist device without degrading the compactness thereof. Consequently, the burden to the user can be relieved. Further, even though the electric component generates heat when electrified, the heat generated by the electric member can be released through the cylindrical link member. Accordingly, there is no need to provide a special cooling device for the electric component, which contributes to the compactness of the walking assist device. Furthermore, since the heat transfer member is disposed at a surface of the seat member opposite to the other surface thereof contacted by the user, the user can be prevented from being subjected to the heat released from the heat transfer member.

### BRIEF DESCRIPTION OF THE DRAWINGS

FIG. 1 is a perspective view illustrating a walking assist device according to an embodiment of the present invention.

FIG. 2 is a side view illustrating the walking assist device according to an embodiment of the present invention.

FIG. 3 is a front view illustrating the walking assist device according to an embodiment of the present invention.

FIG. 4 is a perspective view illustrating a seat member of the walking assist device according to an embodiment of the present invention.

FIG. 5 is a perspective view illustrating partially a leg link of the walking assist device according to an embodiment of the present invention.

### DETAILED DESCRIPTION OF THE PREFERRED EMBODIMENTS

A walking assist device according to an embodiment of the present invention will be described hereinafter.

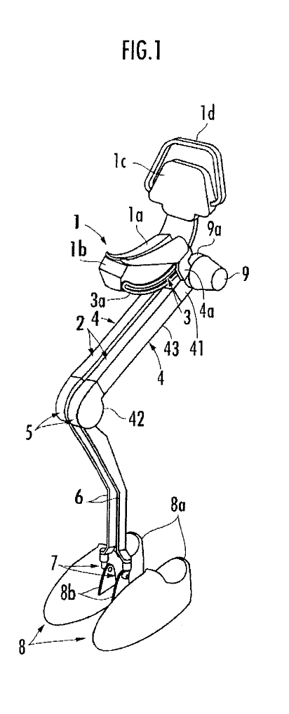

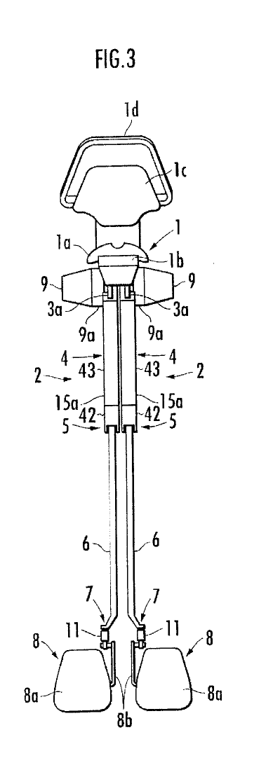

As illustrated in FIG. 1 through FIG. 3, the walking assist device is provided with a seat member 1 which is equivalent to a load transmit portion where a user P sits astride, a pair of left and right leg links 2 and 2 connected to the seat member 1.

Each leg link 2 is a freely stretchable and bendable link composed of a first link 4 connected to the seat member 1 through a first joint portion 3 at the upper end portion of the first link 4 and a second link 6 connected to the lower end portion of the first link 4 through a rotary second joint portion 5. The lower end portion of the second link 6 is connected through a third joint portion 7 to a foot installation portion 8 to be mounted by each foot of the user P.

Each leg link 2 is further mounted with a driving source 9 for driving the second joint portion 5. When the second joint portion 5 is driven by the driving source 9 to rotate, each leg link 2 is operated to move in the stretching direction, namely, in the direction of pushing the seat member 1 upward, to generate a support force supporting a partial body weight of the user (hereinafter referred to as body weight relieving assist force). The body weight relieving assist force generated by each leg link 2 is transmitted to the body trunk of the user P through the seat member 1 to relieve the load applied to the feet of the user P.

The seat member 1 is composed of a seat portion 1a where the user P sits, a support frame 1b, and a waist supporter 1c. The seat portion 1a is of a saddle shape. The support frame 1b is disposed below the seat portion 1a to support the seat portion 1a. The support frame 1b is configured to extend upward behind the seat portion 1a. The support frame 1b has an uprising portion at a rear end thereof. The waist supporter 1c is fixed at the uprising portion. The waist supporter 1c is provided with a holding portion 1d of an arch shape to be held by the user P if necessary.

When the user P sits on the seat member 1, each leg link 2 is positioned inward each leg of the user P in the lateral direction. Therefore, when the walking assist device is in use, the seat member 1 and the leg links 2 are positioned below the hip of the user P. Consequently, the hands of the user will not hit the seat member 1 or the leg links 2 while walking. Thereby, free hand swing in walking is enabled, making the walking assist device more convenient for use.

The first joint portion 3 at the upper end portion of each leg link 2 has a guide rail 3a of an arc shape disposed below the seat member 1. Each leg link 2 is movably engaged with the guide rail 3a via a plurality of rollers 4b pivotally attached to a slider 4a which is fixed at the upper end portion of the first link 4. In this way, each leg link 2 swings in the anteroposterior direction around the center of curvature of the guide rail 3a. The anteroposterior swing fulcrum of each leg link 2 functions as the center of curvature of the guide rail 3a.

Furthermore, the guide rail 3a is pivotally supported at the uprising portion formed at the rear end of the support frame 1b of the seat member 1 via a spindle 3b disposed in the anteroposterior direction. Therefore, the guide rail 3a is connected to the seat member 1, capable of swinging freely in the lateral direction. Accordingly, each leg link 2 is allowed to swing in the lateral direction, which enables the user P to abduct the legs thereof. In addition, the center of curvature of the guide rail 3a and the axis line of the spindle 3b are both located above the seat portion 1a. Thereby, the seat member 1 can be prevented from inclining greatly both in the vertical direction and the lateral direction when the user P shifts the body weight thereof.

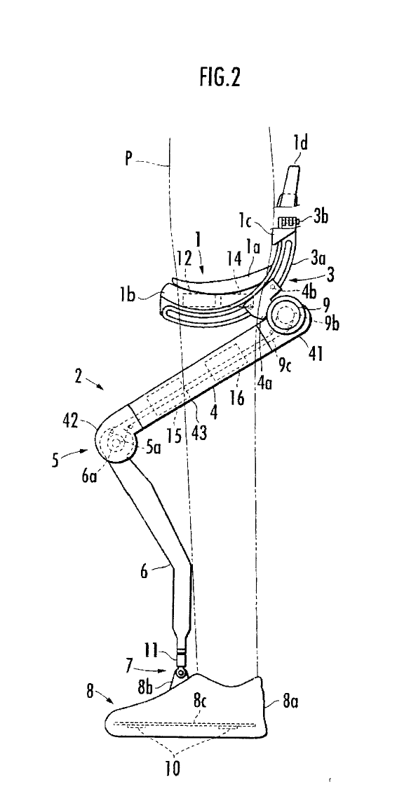

The driving source 9 is an electric motor provided with a reduction gear 9a which is attached to a lateral surface of the upper end portion of the first link 4 of each leg link 2. As illustrated in FIG. 2, an output member of the reduction gear 9a, that is, a driving pulley 9b and a driven pulley 6a which is fixed concentrically with a joint axis 5a of the second joint portion 5 at the second link 6 are connected through a wrapping transmission member 9c, such as a wire, a chain, a belt or the like. Thereby, the driving force output from the driving source 9 through the reducing gear 9a is transmitted through the wrapping transmission member 9c to the second link 6 so that the second link 6 swings around the joint axis 5a with respect to the first link 4 to stretch or bend the leg link 2.

Each ground contacting portion 8 is composed of a shoe 8a and a connection member 8b which is fixed at the shoe 8a and extends upward. The second link 6 of each leg link 2 is connected 1C to the connection member 8b through the third joint portion 7 of a 3-axis structure. As illustrated in FIG. 2, a pair of longitudinally disposed pressure sensors 10 and 10, which detect loads applied to the metatarsophalangeal joint (MP joint) and the heel of each foot of the user P, respectively, are attached to the undersurface of an insole 8c provided in the shoe 8a. Moreover, a 2-axis force sensor 11 is built into the second joint portion 7.

The walking assist device is provided with a battery 12, a power source plate 13, a controller 14, a sensor amplifier 15 and a motor driver 16 as electric components to be used for controlling the driving source 9. Detection signals from the pressure sensors 10 and the force sensor 11 are input into the controller 14 after amplified by the sensor amplifier 15. On the basis of the detection signals from the pressure sensors 10 and the force sensor 11, the controller 14 performs a walking assist control by controlling the driving source 9 through the motor driver 16 to drive the second joint portion 5 of the leg link 2 to generate the body weight relieving assist force.

The body weight relieving assist force is applied on a connection line (hereinafter, referred to as a reference line) joining a swing fulcrum of the leg link 2 with respect to the first joint portion 3 in the anteroposterior direction and a swing fulcrum of the leg link 2 with respect to the third joint portion in the anteroposterior direction. In the walking assist control, the actual body weight relieving assist force applied on the reference line (accurately, a resultant force between the body weight relieving assist force and a force generated by the weights of the seat member 1 and each leg link 2) is calculated based on detection values of forces in the two-axis direction detected by the force sensor 11. Thereafter, on the basis of the stepping force detected by the pressure sensors 10 in each foot installation portion 8, a ratio of the stepping force of each leg with respect to the resultant force from both legs of the user P is calculated. Then, a desired control value of the body weight relieving assist force which should be generated in each leg link 2 is calculated by multiplying a predefined value of the body weight relieving assist force by the calculated ratio of the stepping force of each leg. Subsequently, the driving source 9 is controlled so as to make the actual body weight relieving assist force calculated on the basis of the detection values by the force sensor 11 approximate to the desired control value.

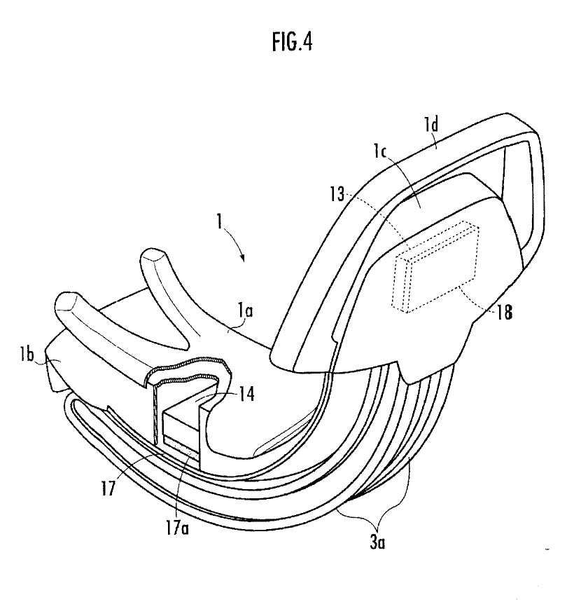

There has been considered that the electric components for controlling the driving source 9 are packed in the backpack to be shouldered by the user, however, this would becomes a burden to the user. According to the present embodiment, the battery 12 and the controller 14 are housed in the seat frame 1b of the seat member 1, and the power source plate 13 is built into the waist supporter 1c as illustrated in FIG. 4. The back surface of the seat frame 1b, in other words, the surface opposite to the other surface where the user of the seat member 1 contacts, is provided with a heat transfer member 17. The heat transfer member 17 is made of a metallic plate with high thermal conductivity, such as aluminum and the like. The heat transfer member 17 is connected to the battery 12 and the controller 14 through a contact layer 17a with good thermal conductivity, such as silicon and the like. Accordingly, the heat transfer member 17 is connected thermally to the battery 12 and the controller 14. Moreover, an inner portion of the waist supporter 1d toward the back side is thermally connected to the power source plate 13 through a heat transfer member 18 made of a metallic plate with high thermal conductivity, such as aluminum and the like.

According to the above-mentioned configuration, by making good use of the seat member 1 as a disposing space for the electric components, the electric components can be reasonably disposed in the walking assist device without degrading the compactness thereof. Even the electric components including the battery 12, the controller 14 and the power source plate 13 generate heat, since the heat transfer members 17 and 18 are provided, the heat generated is released through the heat transfer members 17 and 18. Accordingly, there is no need to provide a special cooling device for the electric components, which contributes to the compactness of the walking assist device. Moreover, since the heat transfer members 17 and 18 are disposed at the surface of the seat member 1 opposite to the other surface thereof contacted by the user P, the user P can be prevented from being subjected to the heat released from the heat transfer members 17 and 18.

As mentioned above, the sensor amplifier 15 and the motor driver 16 are needed to control the driving source 9 in addition to the controller 14. However, it is spatially difficult to dispose the controller 14, the sensor amplifier 15 and the motor driver 16 inside the seat member 1. In this regard, the present embodiment makes good use of the long component, that is, the first link 4 of the leg link 2 as the disposing space for the sensor amplifier 15 and the motor driver 16. As to be described hereinafter, the sensor amplifier 15 and the motor driver 16 can be reasonably disposed in the walking assist device without degrading the compactness thereof.

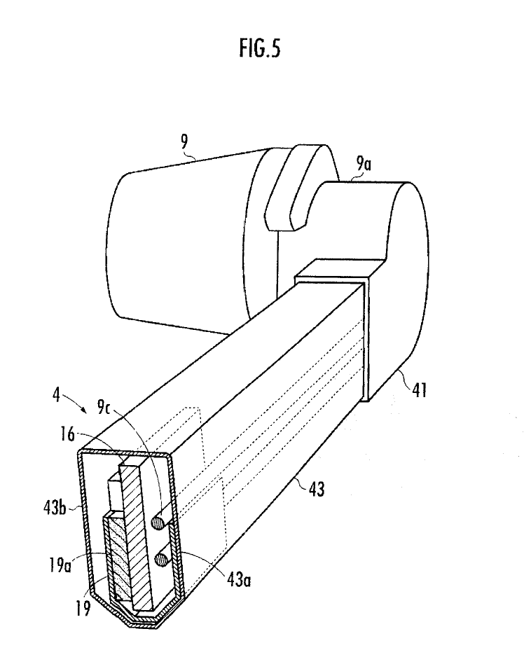

The first link 4 includes an upper first case portion 41 where the driving source 9 is disposed, a lower second case portion 42 covering the second joint portion 5, and a cylindrical link member 43 joining the first case portion 41 and the second case portion 42 as illustrated in FIG. 5. The cylindrical link member 43 is made of dielectric material such as a metal. The sensor amplifier 15 and the motor driver 16 are housed inside the cylindrical link member 43 (only the motor driver 16 is illustrated in FIG. 5).

Moreover, a heat transfer member 19 is disposed inside the cylindrical link member 43. The cylindrical link member 43 and the built-in electric components composed of the sensor amplifier 15 and the motor driver 16 are thermally connected through the heat transfer member 19. The heat transfer member 19 is mace of a metallic plate with high thermal conductivity, such as aluminum and the like. The heat transfer member 19 is formed into a U-shape in profile to avoid interfering with the wrapping transmission member 9c inserted through the cylindrical link member 43. One side plate of the heat transfer member 19 in the lateral direction is joined to the built-in electric components 14 and 15 through a contact layer 19a with good heat conductivity, such as silicon and the like, the other side plate of the heat transfer member 19 is joined through screwing or welding to the inner surface of a side plate 43a at the inner side of the cylindrical link member 43 in the lateral direction, opposite to the surface contacted by the legs of the user P.

According to the above-mentioned configuration, since the electric components 15 and 16 are housed in the cylindrical link member 43 of the leg link 2, the protection of the electric components 15 and 16 against mechanical damage, dust and water can be achieved without the need of providing extra covering members. Further, the cylindrical link member 43 is made of dielectric material, the built-in electric components 15 and 16 can be protected against external electromagnetic waves, and as a result thereof, malfunctions due to incoming noises can be prevented.

Moreover, even the built-in electric components 15 and 16 generate heat when electrified, since the cylindrical link member 43 is long and has a relatively greater heat capacity, the heat generated by the built-in electric components 15 and 16 can be transferred to the cylindrical link member 43 through the heat transfer member 19 and absorbed by the cylindrical link member 43. Accordingly, there is no need to provide special cooling devices for the built-in electric components 15 and 16, which contributes to the compactness of the walking assist device.

Since the heat transfer member 19 is thermally connected to the side plate 43a at the inner side of the cylindrical link member 43 in the lateral direction, the side plate 43b at the outer side of the cylindrical link member 43, facing the legs of the user P, will not effected by the heat released from the side plate 43a, and thus, the temperature thereof will not become too high. Therefore, the user P will not feel uncomfortable by the heat applied to the legs thereof.

Although the embodiment of the present invention has been described in the above with reference to the drawings, the present invention is not limited thereto. For example, in the embodiment mentioned above, the heat transfer members 17, 18 and 19 have been described to be made of metallic plates; however, it is acceptable for them to be made of heat pipes. In the embodiment mentioned above, the sensor amplifier 15 and the motor driver 16 have been described to be housed in the cylindrical link member 43 which constitutes the first link 4 of the leg link 2; however, it is acceptable to constitute at least a part of the second link 6 with a cylindrical link member and house the sensor amplifier therein. In the embodiment mentioned above, each leg link 2 has been described to be a freely stretchable and bendable link with the rotary second joint portion 5 disposed therein; however, it is acceptable that the leg link 2 is configured as a freely stretchable and bendable link with a linear second joint portion. In the embodiment mentioned above, the first joint portion 3 is configured to have the arc-shaped guide rail 3a and the anteroposterior swing fulcrum of each leg link 2 with respect to the first joint portion 3 is located above the seat portion 1a of the seat member 1; however, it is not limited thereto. For example, the first joint portion 3 may be configured as a simple-structured joint portion having a spindle to pivotally support each leg link 2 so that the upper end portion thereof can freely swing in the anteroposterior direction.

In the embodiment mentioned above, the seat member 1 is configured as the load transmit portion; however, it is acceptable to adopt a belt mounted around the waist of the user as the load transmit portion. Moreover, in order to assist the walking of a handicapped user whose one leg is crippled due to bone fracture or the like, it is possible to leave only one leg link of the left and right leg links 2 and 2 in the above-mentioned embodiment corresponding to the crippled leg of the user by removing the other.

1. A walking assist device comprising a load transmit portion a leg link connected to the load transmit portion, and a driving source, said leg link being provided with at least one joint portion and the driving source for driving the joint portion being provided in the leg link, said walking assist device being operable to support at least a partial weight of a user with the leg link through the load transmit portion by operating the driving source to drive the joint portion to make the leg link push up the load transmit portion, wherein
the leg link is at least partially constituted of a cylindrical link member;
the cylindrical link member is configured to at least partially house an electric component for controlling the driving source; and
the cylindrical link member and the electric component housed in the cylindrical link member are thermally connected to one another by a heat transfer member.

2. The walking assist device according to claim 1, wherein the cylindrical link member is made of dielectric material.

3. The walking assist device according to claim 1, wherein
the load transmit portion is composed of a seat member where the user sits astride,
the leg link is disposed inward a leg of the user in a lateral direction of the leg, and
the heat transfer member is thermally connected to a side plate disposed inward the cylindrical link member in a lateral direction of the cylindrical link member.

4. A walking assist device, comprising a load transmit portion, a leg link, and a driving source, said load transmit portion including a seat member upon a user sits astride, said leg link being connected to the load transmit portion and being provided with at least one joint portion, said driving source for driving the joint portion being provided in the leg link, said walking assist device being operable to support at least a partial weight of the user with the leg link through the load transmit portion by operating the driving source to drive the joint portion to make the leg link push up the load transmit portion, wherein
the seat member is configured to at least partially house an electric component for controlling the driving source;
a heat transfer member is disposed at a surface of the seat member opposite to a surface thereof contacted by the user; and
the heat transfer member is thermally connected to the electric component disposed in the seat member.
